(19) United States
(12) Patent Application Publication
(10) Pub. No.: US 2024/0231252 A1
(43) Pub. Date: Jul. 11, 2024

(54) TONER, TONER ACCOMMODATING UNIT, IMAGE FORMING APPARATUS, AND IMAGE FORMING METHOD

(71) Applicants: Akihiro KANEKO, Kanagawa (JP); Masayuki ISHII, Shizuoka (JP); Kaede MASUKO, Shizuoka (JP)

(72) Inventors: Akihiro KANEKO, Kanagawa (JP); Masayuki ISHII, Shizuoka (JP); Kaede MASUKO, Shizuoka (JP)

(21) Appl. No.: 18/402,756

(22) Filed: Jan. 3, 2024

(30) Foreign Application Priority Data
Jan. 6, 2023 (JP) 2023-001194

(51) Int. Cl. G03G 9/097; G03G 9/08; G03G 9/087; G03G 15/08; G03G 15/16; G03G 15/20

(52) U.S. Cl. CPC G03G 9/09775; G03G 9/0827; G03G 9/08711; G03G 9/09733; G03G 15/08; G03G 15/16; G03G 15/2064

(57) ABSTRACT

A toner is provided that contains a mother toner particle containing a binder resin, a release agent, and a charge control agent and an external additive containing a hydrophobized polymethylsilsesquioxane particle, wherein the toner has a glass transition temperature of from 48 to 60 degrees C., and the temperature of 1.0 g of the toner is from 54 to 65 degrees C. when the 1.0 g of the toner is pushed in 0.1 mm by the piston of a flow tester in heating the 1.0 g of the toner from 40 degrees C. at a temperature rising speed of 3 degrees C. per minute under a load of 22.5 kgf.

### CROSS-REFERENCE TO RELATED APPLICATIONS

This patent application is based on and claims priority pursuant to 35 U.S.C. § 119 to Japanese Patent Application No. 2023-001194, filed on Jan. 6, 2023, in the Japan Patent Office, the entire disclosure of which is hereby incorporated by reference herein.

### BACKGROUND

### Technical Field

The present disclosure relates to a toner, a toner accommodating unit, an image forming apparatus, and an image forming method.

### Description of the Related Art

In electronic photography's image-forming process, an electrostatic charge image (latent image) is created on a photoconductor and then developed with toner to generate a visible toner image.

For optimal image formation, minimizing external factors that affect the toner's ability to hold charge is crucial. These factors encompass various influences, including in-machine stress, which can occur when toner remains in the developing section for prolonged periods. This stress can cause deformation or cracking of toner particles and the burial of external additives on the surface. Consequently, alterations in the toner's particle size distribution, shape, adhesion, and flowability significantly impact its chargeability, especially during printing with low toner coverage.

Conversely, there is a growing demand for toners with a low occurrence temperature of cold offset and excellent low-temperature fixing capabilities. This demand is driven by the need for energy conservation and the compact design of devices like copiers. Such requirements are particularly pertinent for monochrome/full-color printers and full-color copiers. Hence, toners and their raw materials are increasingly formulated to have lower melting points, prompting the utilization of lower molecular weight materials in today's formulations.

### SUMMARY

According to embodiments of the present disclosure, a toner is provided that contains a mother toner particle containing a binder resin, a release agent, and a charge control agent and an external additive containing a hydrophobized polymethylsilsesquioxane particle, wherein the toner has a glass transition temperature of from 48 to 60 degrees C., and the temperature of 1.0 g of the toner is from 54 to 65 degrees when the 1.0 g of the toner is pushed in 0.1 mm by the piston of a flow tester in heating the 1.0 g of the toner from 40 degrees C. at a temperature rising speed of 3 degrees C. per minute under a load of 22.5 kgf.

As another aspect of embodiments of the present disclosure, a toner accommodating unit is provided that contains the toner mentioned above.

As another aspect of embodiments of the present disclosure, an image forming apparatus is provided that includes a latent electrostatic image bearer, a latent electrostatic image forming device for forming a latent electrostatic image on the latent electrostatic image bearer, a developing device for developing the latent electrostatic image formed on the latent electrostatic image bearer with the toner mentioned above to obtain a visible image, a transfer device for transferring the visible image onto a transfer medium, and a fixing device for fixing the visible image transferred to the transfer medium.

As another aspect of embodiments of the present disclosure, an image forming method is provided that includes forming a latent electrostatic image on a latent electrostatic image bearer, developing the latent electrostatic image formed on the latent electrostatic image bearer with the toner mentioned above to obtain a visible image, transferring the visible image formed on the latent electrostatic image bearer to a transfer medium, and fixing the visible image on the transfer medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus employing a tandem system according to an embodiment of the present invention;

FIG. 2 is a partially enlarged diagram illustrating the diagram illustrated in FIG. 1.

FIG. 3 is a diagram illustrating an example of the process cartridge as the toner accommodating unit of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an.” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a toner is provided which excels in resistance to stress and low-temperature fixing properties, and can form high-quality images over the long term.

### Toner

The toner of the present disclosure contains mother toner particles each containing a binder resin, a release agent, and a charge control agent, an external additive, and other optional components.

The external additive has a glass transition temperature of 48 to 60 degrees C. and contains hydrophobized polymethylsilsesquioxane particle. The temperature of 1.0 g of the toner is from 54 to 65 degrees C. when the 1.0 g of the toner is pushed in 0.1 mm by the piston of a flow tester in heating the 1.0 g of the toner from 40 degrees C. at a temperature rising speed of 3 degrees C. per minute under a load of 22.5 kgf. The toner may be referred to as “electrophotographic toner.

The inventors of the present invention have formulated the toner of the present invention based on the identification of issues in conventional technologies.

Specifically, the toners and toner binder disclosed in documents such as patent literatures of Unexamined Japanese Patent Application Publication Nos 2014-85566, 2010-151996, 2014-199422, and 2014-164034 need improvements in addressing an issue of external additives embedded on toner particles' surfaces due to stress in the development process. Improving the low-temperature fixability is linked to reducing the resilience of toner particles during the development process. This improvement may lead to increased embedding of external additives onto the toner's surface, resulting in decreased chargeability and flowability. These factors collectively deteriorate the image quality.

Research conducted by the inventors of the present invention reveals that a toner lacking hydrophobized polyethylene particles exhibits diminished chargeability, resulting in the production of defective toner images. Particularly, the image density diminishes toward the latter portion of the paper when solid images are printed.

The main cause of this phenomenon is the stress encountered during the development process, leading to the exposure of mother toner particles due to the embedding or detachment of external additives. This exposure alters the surface properties of the toner particles, reducing their flowability and subsequently causing issues with charge and conveyance.

The present inventors of the present invention have made an investigation to solve this issue in conventional technologies and formulated the following toner.

The toner contains a mother toner particle that contains a binder resin, a release agent, and a charge control agent, along with an external additive that contains a hydrophobized polymethylsilsesquioxane particle; and it has a glass transition temperature of from 48 to 60 degrees C., and the temperature of 1.0 g of the toner is from 54 to 65 degrees C. when the stroke position at 40 degrees C. is pushed in 0.1 mm by the piston of a flow tester while the 1.0 g of the toner is heated at a temperature rising speed of 3 degrees C. per minute under a load of 22.5 kgf.

This toner exhibits exceptional low-temperature fixability and extremely high surface retention, thanks to the inclusion of hydrophobized polymethylsilsesquioxane particles. These components ensure consistent chargeability and flowability even under the stress of the development process. In summary, this formulated toner excels in both the low-temperature fixability and resilience to stress, enabling the creation of high-quality images over an extended period.

Toner with Low Temperature Fixability

The incorporation of hydrophobized polymethylsilsesquioxane significantly enhances the performance of mother toner particles, particularly in achieving exceptional low-temperature fixability while mitigating their vulnerability to stress during the development process.

The toner in one embodiment of the present invention that excels in low temperature fixability has a glass transition temperature of 48 to 60 degrees C. and a temperature t of 54 to 65 degrees C. The temperature t represents the temperature of 1.0 g of the toner at the stroke position P of the piston of a flow tester pushed in 0.1 m from the stroke position P at 40 degrees C. under a load of 22.5 kgf while 1.0 g of the toner is heated at a temperature rising speed of 3 degrees C. per minute as measured with the flow tester as shown in the relationship 1 below.

$$P ( t degrees C . ) = 0.1 + P ( 40 degrees C . ) \qquad Relationship 1$$

A glass transition temperature of 48 or lower degrees C. significantly reduces storage stability under heat conditions and increases the risk of particle aggregation and adhesion during continuous printing using actual equipment.

On the contrary, a glass transition temperature of 60 or higher degrees C. elevates the threshold temperature at which cold offsetting occurs, potentially compromising the low-temperature fixability.

### Measuring of Glass Transition Temperature Tg of Binder Resin

The glass transition temperature Tg is determined using a differential scanning calorimeter (DSC 210, available from Seiko Instruments Inc.). Specifically, a sample weighing between 0.001 to 0.01 g is loaded into an aluminum pan. The sample undergoes a heating cycle from room temperature to 200 degrees C., followed by cooling to 0 degrees C. at a rate of 10 degrees C. per minute, and then reheating at a rate of 10 degrees C. per minute.

The Tg is identified as the intersection point between the extended baseline, which should not exceed the temperature of the endothermic peak, and the tangent showing the steepest slope of the rising part of the peak to its apex.

Measuring Efflux Initiation Temperature t with Flow Tester

The temperature t representing the temperature of 1.0 g of the toner at the stroke position P pressed in 0.1 m from the stroke position P at 40 degrees C. under a load of 22.5 kgf while 1.0 g of the toner is heated at a temperature rising speed of 3 degrees C. per minute as measured with a flow tester is identified in the following manner.

Specifically, in measuring the temperature t with a flow tester (CFT-500D, available from Shimadzu Corporation), 1.0 g of the toner sample is heated at a temperature rising speed of 3 degrees C./minute under a load of 22.5 kgf by the piston of the flow tester to be extruded through a nozzle with a diameter of 1.0 mm and a length of 1.0 mm. The piston descent of the flow tester is then plotted against temperature. Suppose the position of the piston at 40 degrees in this plot is P (40 degrees C.) and the position of the piston at t degrees C. is P (t degrees C.). In that case, the temperature t measured is determined as the efflux initiation temperature.

A toner with a temperature t lower than 54 degrees C. is likely to cause resin deformation when exposed to heat. This deformation causes the toner to change its shape, leading to the external additives being embedded into the toner's surface during extended agitation within the developing unit. Consequently, this results in the production of defective toner images.

A toner with a temperature t exceeding 65 degrees C. does not melt easily during the heat and pressure fixing process, leading to inadequate adhesion between the toner and paper. Consequently, the toner faces detachment issues when scraped.

On the other hand, the temperature t between 54 and 65 degrees C. is linked to firmly hold external additives on the surface upon application of heat and promote the melting of toner particles during the heat and pressure fixing process. As a result, the toner demonstrates effective low-temperature fixability and exceptional resilience to stress, maintaining the hydrophobized polymethylsilsesquioxane feature as an external additive even when the mother toner is under stress during the development process.

### Mother Toner Particle

The mother toner particle (hereinafter also referred to as mother toner or mother particle) contains a binder resin and a release agent, and preferably, a tri- or higher valent metal salt, a colorant, and a charge control agent. The mother toner particle may furthermore optionally contain other components.

The mother toner particle is preferably pulverized toner.

### Binder Resin

The binder resin is preferably styrene acrylic resin to achieve high compatibility with a release agent.

The styrene acrylic resin is not particularly limited and can be suitably selected from copolymers containing any styrene monomer and acrylic monomer known in the art to suit to a particular application. The monomer may contain other substances such as other monomers and cross-linking agents.

Specific examples of the styrene monomer include, but are not limited to, o-methylstyrene. m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene.

These can be used alone or in combination.

Specific examples of the acrylic monomer include, but are not limited to, acrylic acid, methacrylic acid, and acrylic or methacrylic acid ester monomers such as acrylic acid methyl ester, methacrylic acid methyl ester, acrylic acid ethyl ester, methacrylic acid ethyl ester, acrylic acid propyl ester, methacrylic acid propyl ester, acrylic acid butyl ester, methacrylic acid butyl ester, acrylic acid octyl ester, methacrylic acid octyl ester, acrylic acid dodecyl ester, methacrylic acid dodecyl ester, acrylic acid stearyl ester, methacrylic acid stearyl ester, acrylic acid behenyl ester, methacrylic acid behenyl ester, acrylic acid 2-ethylhexyl ester, methacrylic acid 2-ethylhexyl ester, acrylic acid dimethylaminoethyl ester, methacrylic acid dimethylaminoethyl ester, acrylic acid diethylaminoethyl ester, methacrylic acid diethylaminoethyl ester.

These can be used alone or in combination.

A cross-linking agent can be added to enhance the mechanical strength of toner particles and control the molecular weight of styrene acrylic resin.

The cross-linking agent is not particularly limited and can be suitably selected to suit to a particular application. Examples include, but are not limited to, difunctional cross-linking agents and tri- or higher functional cross-linking agents.

These can be used alone or in combination.

Specific examples of the difunctional cross-linking agents include, but are not limited to, divinylbenzene, bis(4-acryloxy polyethoxyphenyl)propane, ethylene glycol diacrylate, 1,3-butyleneglycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, each of polyethylene glycol #200, #400, and #600 diacrylates, dipropyleneglycol diacrylate, polypropyleneglycol diacrylate, and their equivalents where the diacrylates are replaced with dimethacrylates.

Specific examples of the tri- or higher functional crosslinking agents, examples include pentaerythritol triacrylate, trimethylolpropane triacrylate, trimethylolethane triacrylate, tetramethylolmethane tetraacrylate, oligoester acrylates and their methacrylate counterparts, 2,2-bis(4-methacryloxy polyethoxyphenyl)propane, diaryl phthalates, triaryl cyanurates, triaryl isocyanurates, triaryl trimellitates, and similar compounds.

### Release Agent

The release agent or wax is not particularly limited and can be suitably selected from any known release agents to suit to a particular application. Containing polyethylene wax is preferable.

These can be used alone or in combination.

The polyethylene wax mentioned above preferably has a melting point of from 80 to 115 degrees C. to balance the heat resistance and offset resistance.

A polyethylene wax with a melting point lower than 80 degrees C. significantly degrades the heat resistance of toner while a polyethylene wax with a melting point higher than 115 degrees C. does not seep easily to the toner's surface during fixing under heat and pressure, lowering the image density.

The polyethylene wax is a polyethylene low polymer obtained industrially through the medium-pressure or low-pressure polyethylene polymerization using Ziegler-Natta catalysts or metallocene catalysts, followed by purifying this polyethylene. Specifically, it is obtained by refining the low polymer of polyethylene to remove oil fractions, oligomers, etc., via methods such as vacuum distillation.

Then the resulting distillation residue can be optionally furthermore processed under high temperature and reduced pressure to appropriately remove the low molecular weight components.

Examples of such polyethylene waxes include, but are not limited to, Neo-Wax (melting point of 110 degrees C., available from Yasuhara Chemical Co., Ltd.) and Polywax 500 (melting point of 88 degrees C. available from TOYOCHEM CO., LTD.), which is a completely saturated ethylene homopolymer.

The proportion of the release agent is not particularly limited and can be suitably selected to suit to a particular application. The number of parts of the release agent is preferably from 1 to 20 parts by mass and more preferably from 2 to 8 parts by mass to 100 parts of the toner. A release agent at one or more parts by mass prevents hot offset resistance and low temperature fixability from lowering. A release agent at 20 or less parts by mass prevents high temperature storage stability from lowering and reduces the chance of fogging in an image obtained.

### Charge Control Agent

The toner of the present disclosure can be negatively or positively charged. The charge control agent can control the polarity of the toner.

There is no specific limit to the selection of the charge control agent and it can be suitably selected to suit to a particular application.

Specific examples include, but are not limited to, nigrosine-based dyes, triphenylmethane-based dyes, chromium-containing metal complex dyes, molybdenum acid chelate pigments, rhodamine-based dyes, alkoxylamines, quaternary ammonium salts (including fluorine-modified quaternary ammonium salts), alkylamides, elemental or compound forms of phosphorus, elemental or compound forms of tungsten, fluorine-based activators, metal salts of salicylic acid, metal salts of salicylic acid derivatives, metal salts of oxy-naphthoic acid, phenol-based condensates, azo-based pigments, boron complexes, or high molecular weight compounds containing functional groups (such as sulfonic acid groups, carboxyl groups, or quaternary ammonium salts). These can be used alone or in combination.

Specific examples of the charge control agents include, but are not limited to, BONTRON 03 (nigrosine dye), BONTRON P-51 (quaternary ammonium salt), BONTRON S-34 (azo dyes containing metal), E-82 (metal complex of oxynaphthoic acid)d E-84 (metal complex of salicylic acid), and E-89 (phenolic condensation product), all of which are manufactured by Orient Chemical Industries Co., Ltd.; TP-302 and TP-415 (molybdenum complex of quaternary ammonium salts), which are manufactured by Hodogaya Chemical Co., Ltd.; COPY CHARGE PSY VP2038 (quaternary ammonium salt), COPY BLUE PR (triphenyl methane derivative). COPY CHARGE NEG VP2036 (quaternary ammonium salt), and COPY CHARGE NX VP434, all of which are manufactured by Hoechst AG; LRA-901 and LR-147 (boron complex), both of which are available from Japan Carlit Co., Ltd.; copper phthalocyanine, perylene, quinacridone, and azo-based pigments.

The proportion of the charge control agent is not particularly limited and can be suitably selected to suit to a particular application. An amount within a range that maintains performance and does not hinder fixability is appropriate. Preferably, it ranges from 0.5 to 5 mass percent, with an even stronger preference from 0.8 to 3 mass percent to the total mass of the resin particles.

These charge control agents can be melted and dispersed after being melt-kneaded with a masterbatch, the amorphous polyester resin, or the crystalline polyester resin. Alternatively, they can be directly added to an organic solvent. Additionally, a charge control agent can be fixed onto the surface of resin particles after their production.

### Trivalent or Higher Metal Salt.

Preferably, the mother toner contains a trivalent or higher metal salt.

The metal salt undergoes a cross-linking reaction with the acid group of the binder resin during fixing, forming a weak three-dimensional network. This network enhances offset resistance while keeping the low temperature fixability.

The trivalent or higher metal salt is preferably at least one of metal salts of salicylic acid derivatives and acetylacetonato metal salts, for example.

As the metal, any trivalent or higher ion metal can be used.

Specific examples include, but are not limited to, iron, zirconium, aluminum, titanium, and nickel.

A specific example of the trivalent or higher metal salts is a trivalent or higher salicylic acid metal compound.

The proportion of the trivalent or higher metal salt is preferably from 0.5 to 2 parts by mass and more preferably from 0.5 to 1 part by mass to 100 parts by mass of the binder resin.

A content less than 0.5 part by mass may degrade the hot offset resistance. A content surpassing 2 part by mass enhances the hot offset resistance gloss but may negatively affects the glossiness and low temperature fixability.

### Colorant

The colorant has no particular limit and can be suitably selected from known dyes and pigments to suit to a particular application.

Specific examples include, but are not limited to, carbon black. Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof.

These can be used alone or in combination.

The colorant can be used as black or full color toner.

The proportion of the colorant is not particularly limited and can be suitably selected to suit to a particular application. The number of parts of the colorant is preferably from 1 to 35 parts by mass and more preferably from 3 to 20 parts by mass to 100 parts by mass of the toner mentioned above.

### External Additive

The external additive contains hydrophobized polymethylsilsesquioxane particles and other optional substances.

### Hydrophobized Polymethylsilsesquioxane Particle

Polymethylsilsesquioxane is a polymer of methyl trimethoxysilane.

This polymer is a silicone resin polymerized by cross-linking methyl trimethoxysilane in a three-dimensional network manner from a chemical structural point of view. The silicone resin is a spherical fine particle. Therefore, polymethylsilsesquioxane is referred to as “a polymethylsilsesquioxane particle”.

The hydrophobized poly methylsilsesquioxane particle can be obtained by subjecting polymethylsilsesquioxane particle to hydrophobization.

The polymethylsilsesquioxane particle preferably has an average particle diameter of from 0.050 to 0.150 μm and more preferably from 0.100 to 0.135 μm.

Polymethylsilsesquioxane particles with an average diameter greater than 0.150 μm do not adhere firmly to the toner's surface, making them prone to rolling and detachment.

The average particle diameter of the polymethylsilsesquioxane particle can be measured utilizing a known method.

Specifically, the polymethylsilsesquioxane particle or a toner with the polymethylsilsesquiox particle externally attached thereto as an external additive is subjected to measuring with a scanning electron microscope (SU8200 series, manufactured by Hitachi High-Technologies Corporation). The external additive particles in an obtained image are recognized by binarization with an image processing software called “A-zou kun”, created by Asahi Kasei Engineering Corporation. Then the circularity, equivalent circle diameter, and particle area of the particle are calculated. The obtained values are determined as those derived from the circular areas. The equivalent circle diameter is obtained as the diameter calculated from the obtained values. The measuring sites are not particularly determined but three or more arbitrary fields are confirmed on a substrate where polymethylsilsesquioxane particles are dispersed in the case of measuring the polymethylsilsesquioxane particle or on toner's surface in the case of measuring the toner. The equivalent circle diameter is calculated for approximately 100 particles, followed by averaging to obtain the average particle diameter.

### Method of Polymethylsilsesquioxane Particle

The polymethylsilsesquioxane particle can be manufactured by mixing and condensing a liquid hydlolyzate containing a hydlolyzate of methyl trimethoxysilane and an anionic surfactant with a precipitate containing water, a basic catalyst, and anionic surfactant.

Specific examples of the anionic surfactant include, but are not limited to, carboxylic acid-type anionic surfactants such as aliphatic monocarboxylates, polyoxyethylene alkyl ether carboxylates, and aliphatic acid oils; sulfonic acid-type anionic surfactants such as dialkyl sulfosuccinates, polyoxyethylene alkyl sulfosuccinates, alkanesulfonates, linear alkylbenzenesulfonates, branched alkylbenzenesulfonates, naphthalenesulfonate-formaldehyde condensates, and alkylnaphthalenesulfonates; sulfate ester-type anionic surfactants such as alkyl sulfates, polyoxyalkylene alkyl ether sulfates, and aliphatic acid sulfates; and phosphate ester-type anionic surfactants such as alkyl phosphates, alkyl phosphates, polyoxyethylene alkyl ether phosphates, and polyoxyethylene alkylaryl ether phosphates. Of these, sulfonic acid-type anionic surfactants and sulfate ester-type anionic surfactants are preferable.

The liquid hydlolyzate preferably furthermore contains an acid catalyst such as an organic acid and an inorganic acid.

Specific examples of the organic acid include, but are not limited to, formic acid, acetic acid, propionic acid, oxalic acid, and citric acid.

Specific examples of the inorganic acid include, but are not limited to, hydrochloric acid, sulfuric acid, nitric acid, and phosphoric acid.

As condense reaction of silanol groups proceeds in mixing the liquid hydlolyzate and the precipitate, polymethylsilsesquioxane particles are formed.

The liquid dispersion of the polymethylsilsesquioxane particle obtained in this reaction is subjected to membrane separation, centrifugal and other methods to obtain polymethylsilsesquioxane particles. The polymethylsilsesquioxane particles can be hydrophobized by surface-treating with hexamethyl disilazane (HMDS) or other substances in the liquid before separation.

The hydrophobized polymethylsilsesquioxane particle can be obtained by subjecting polymethylsilsesquioxane particles to hydrophobizing with a hydrophobizing agent.

Examples of the hydrophobizing agent include, but are not limited to, known organic silicon compounds with an alkyl group (for example, a methyl group, an ethyl group, a propyl group, or a butyl group).

Specific examples include silazane compounds (for example, silane compounds such as methyltrimethoxysilane, dimethyldimethoxysilane, trimethylchlorosilane, and trimethylmethoxysilane, hexamethyldisilazane, and tetramethyldisilazane). These may be used alone or in a combination of two or more thereof.

Of these, organic silicon compounds with a trimethyl group such as trimethylmethoxysilane and hexamethyldisilazane are preferable. In addition, silicon oil treatment may be used.

This hydrophobizing prevents particles from agglomerating and enhances the dispersibility to mother toner. In addition, the impact of severe environmental conditions such as high temperature and high humidity or low temperature and low humidity can be reduced, achieving stable image quality.

The proportion of the hydrophobized polymethylsilsesquioxane particle is preferably from 0.05 to 0.5 parts by mass to 100 parts by mass of the toner. A proportion of 0.5 parts by mass or less reduces the occurrence of filming. A proportion of 0.05 parts by mass or greater can reduce fluctuation of flowability and chargeability over a long period of time, which leads to an advantage of achieving high image quality.

### Other External Additive

The toner in the present disclosure includes, at minimum, hydrophobized polymethylsilsesquioxane particles. Additionally, it may incorporate other external additives, allowing the use of two or more types of additives in combination.

Other external additives include abrasive agents such as silica, powdered Teflon® resin, powdered polyvinylidene fluoride, powdered cerium oxide, powdered silicon carbide, and powdered strontium titanate; flow improvers and anti-agglomeration agents such as powdered titanium oxide, and powdered aluminum oxide; and conductive agents such as powdered zinc oxide, powdered antimony oxide, and powdered tin oxide. Additionally, white and black fine particles with opposite polarity can be used as developing improvers.

These can be used alone or in combination and selected to provide resistance against developing stresses such as idling.

### Properties of Toner

### Volume Average Particle Diameter of Toner

The volume average particle diameter of toner and mother toner can be measured by various methods. One way of determining the volume average particle diameter is to: disperse the target toner in an electrolyte solution containing a surfactant with an ultrasonic dispersing device (from Honda Electronics Co., Ltd.) for one minute; subsequently, measure 50,000 particles using the Coulter Multisizer III available from Beckman Coulter, Inc.; and calculate the average diameter from these measurements.

### Average Circularity of Toner

The mother toner preferable has an average circularity of 0.96 or less and preferably from 0.890 to 0.96.

Mother toner particles with an average circularity of 0.96 or less can avoid producing foul images attributable to a poorly cleaned surface of an image bearer or transfer belt if the toner is used in a system employing blade cleaning. Such poor cleaning performance is not an issue in the case of development or transfer with low toner coverage because the residual toner remaining after transfer is minimal. However, toner may persist and accumulate on an image bearer like a photoconductor if images are incompletely transferred due to medium feeding trouble or extremely high toner coverage, especially in color photo images. The accumulated toner could lead to background fouling on images. In addition, the toner may contaminate the charging roller for charging a member such as an image bearer in a contact manner, thereby degrading the original charging power of the roller. A mother toner particle with an average circularity of 0.96 or less prevents such drawbacks.

One way of measuring the shape of toner particles or mother toner particles is to use optical detection band techniques of passing a suspension containing toner particles through an imaging detection zone on a flat plate, optically detecting particle images with a charge coupled device (CCD) camera, and analyzing them.

The average circularity of the toner particle or mother toner particle is obtained by dividing the circumferential length of a circle having the area equal to the projected toner area obtained with this technique by the circumferential length of an actual particle.

The average circularity of the mother toner particle is determined by measuring the particles using a flow particle image analyzer (FPIA-3000, available from Sysmex Corporation) and analysing with an analysis software (FPIA-3000, Data Processing Program For FPIA Version 00-10).

A specific way of measuring is: 0.1 to 0.5 mL at 10 percent by mass surfactant (alkylbenzene sulfonate, NEOGEN SC-A, available from Daiichi Kogyo Co., Ltd.) was placed in a glass beaker; fine particles are added followed by stirring with a microspatula; and 80 ml of deionized water was added to the resulting mixture. The thus-obtained liquid dispersion is subjected to dispersion treatment for three minutes utilizing an ultrasonic wave dispersion device (manufactured by Honda Electronics Co., Ltd.). The shape and distribution of the fine particles are measured until the concentration of the liquid dispersion reaches 5,000 to 15,000 particles/μl using FPIA-3000.

### Measuring Molecular Weight of Resin

The number average molecular weight and the weight average molecular weight of the resin is obtained by measuring the molecular weight distribution of the portion of the toner dissolved in tetrahydrofuran (THF) with a gel permeation chromatography (GPC) measuring instrument (GPC-150C, available from Waters Corporation).

Measuring is carried out using a column (KF801 to 807, available from SHOWA DENKO K.K) as follows. The column is stabilized in a 40-degrees C. heat chamber followed by the passage of THF as a solvent through the column at 1 mL/min at this temperature. A total of 0.05 g of a sample is sufficiently dissolved in 5 g of THE followed by filtering with a filter for preprocessing (Chromatodisc having hole diameter of 0.45 μm, available from Kurabo Industries Ltd.). In the end, a THF sample solution of resin is adjusted from 0.05 to 0.6 percent by mass as the sample concentration and 50 to 200 μL of the THF sample solution is infused for measuring. The weight average molecular weight Mw and the number average molecular weight Mn of the sample portion dissolved in THE are calculated based on the relationship between the count values and the logarithm values of the calibration curves made from several types of monodispersed polystyrene standard samples.

As the standard polystyrene sample for the standard curve, polystyrene samples having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from Pressure Chemical Co. or TOSOH CORPORATION are used. Using at least about 10 standard polystyrene samples is appropriate, so these samples are used. In addition, a refractive index (RI) detector is used as the detector.

### Method of Manufacturing Toner

The toner can be manufactured by a method known in the art including melt-kneading toner materials, pulverizing the melt-kneaded matter obtained, classifying the pulverized matter obtained to obtain mother toner particles, and externally-adding an external additive to the mother toner particle obtained.

In the melt-kneading, the toner materials are mixed and the mixture obtained is charged in a melt-kneading machine for melt-kneading. The melt-kneading machine includes, but is not limited to, a single or twin screw continuous melt-kneader and a batch-melt-kneader using a roll mill.

Specific examples include, but are not limited to, a KTK type twin screw extruder manufactured by Kobe Steel, Ltd., a TEM type extruder manufactured by Toshiba Machine Co., Ltd., a twin screw extruder manufactured by KCK Engineering, a PCM-type twin screw extruder, manufactured by Ikegai Corp., and a kokneader manufactured by Buss Ag.

Preferably, this melt-kneading is conducted under suitable conditions to avoid severing the molecular chain of a binder resin.

Specifically, the temperature in the melt-kneading is determined according to the softening point of the binder resin. When the temperature is too high relative to the softening point, the molecular chain is likely to be severely severed. When the temperature is too low relative to the softening point, dispersion may not proceed smoothly.

In the pulverizing, the melt-kneaded matter obtained in the melt-kneading is pulverized. In this pulverizing, the melt-kneaded matter is preferably subjected to coarse pulverizing, followed by fine pulverizing. The melt-kneaded matter is pulverized by colliding with a collision board in a jet stream, colliding particles in a jet stream, or pulverizing at narrow gaps between a stator and a rotor that mechanically rotates.

In the classifying, the pulverized matter obtained in the pulverizing is classified and adjusted to have a predetermined particle diameter. The pulverized matter can be classified by removing fine particles with a device such as a cyclone, a decanter, or a centrifugal. After the pulverizing, the pulverized matter is classified in an air stream by centrifugal to manufacture mother toner particles with a predetermined particle diameter.

In the externally adding, an external additive is externally added to the mother toner particles obtained in the classifying. The mother toner particle and external additive are mixed and stirred with a mixer. The mixer cracks the extremal additive and the cracked external additive covers the surface of the mother toner particle.

External additives can adhere to mother toner particles by applying a mechanical impact caused by mixing and stirring.

Specific methods of applying mechanical impact include, but are not limited to, using a high-speed rotating blade to impact particles and employing jet air to accelerate and collide particles against each other or directing agglomerated particles towards a collision board for impact.

Specific examples of such mechanical impact applicators include, but are not limited to, machines such as ONG MILL (manufactured by Hosokawa Micron Co., Ltd.), modified I TYPE MILL (manufactured by Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (manufactured by Kawasaki Heavy Industries. Ltd.), and automatic mortars.

### Developing Agent

The developing agent relating to the present disclosure contains at least the toner and other suitably selected optional components such as carrier.

The toner of the present disclosure can be employed as a single-component developing agent consisting solely of the toner or as a two-component developing agent formed by mixing it with a carrier. Using the toner in a single-component developer is preferable due to its inherent advantages, including robust stress resilience, excellent low-temperature fixability, and the consistent production of high-quality images over an extended period, even though single-component developers are more susceptible to stress within an image-forming apparatus. Conversely, a two-component developing agent is preferable for high-performance printers that support the recent advancements in information processing speed to prolong their operational lifespan.

In the case that the developing agent is a two-component developing agent containing the toner of the present disclosure and carrier, the carrier can be magnetic or non-magnetic carrier depending on the type of the two-component developing method employed.

Examples of the magnetic carrier include, but are not limited to, spinel ferrites such as magnetite and gamma ferric oxide, spinel ferrites containing one or two types of metals such as Mn, Ni, Zn, Mg, and Cu other than iron, magnetoplumbite type ferrites such as barium ferrite, and iron or alloyed metal particles with an oxidized layer on the surface.

The shape of the magnetic carrier may be granular, spherical, or needle-like.

Of these, a strongly-magnetic fine particles such as iron particles is particularly preferable to obtain highly magnetized particles. For chemical stability, spinel ferrites including magnetite and gamma ferric oxide and magnetoplumbite type ferrites such as barium ferrite are preferable.

Specific magnetoplumbite type ferrites include, but are not limited to, MFL-35S, MFL-35HS (both manufactured by Powdertech Co., Ltd.), DFC-400M, DFC-410M, and SM-350NV (all manufactured by DOWA IP Creation Co., Ltd.).

As the magnetic carrier, it is possible to use resin carrier containing magnetic fine particles such as strongly-magnetized fine particles desirably magnetized depending on its type and content.

Such resin carrier preferably has a magnetization of from 30 to 150 emu/g at 1,000 oersted.

The resin carrier can be manufactured by the following method of: spraying melt-kneaded matter of magnetized fine particles and an insulated binder resin with a spray drier; manufacturing resin carrier in which magnetized fine particles are dispersed in a condensed binder resin by allowing to react and cure monomers and prepolymers in an aqueous medium under the presence of magnetized fine particles; fixating positively or negatively-charged or conductive fine particles on a magnetic carrier's surface; coating a magnetic carrier's surface with resin; or coating a magnetic carrier's surface with resin containing positively or negatively-charged or conductive fine particles. These methods adjust the chargeability of resin carrier.

The resin for coating includes, but is not limited to, a silicone resin, acrylic resin, epoxy resin, and fluorine-containing resin. Of these, a silicone resin and an acrylic resin are preferable.

The proportion of the carrier in the two-component developing agent mentioned above is preferably from 85 to lower than 98 percent by mass. A proportion of the carrier of 85 percent by mass or greater reduces the occurrence of a defective image caused by frequent scattering of toner from a developing device. A proportion of the carrier of less than 98 percent by mass inhibits the amount of charge of a toner for electrophotographic developing from extremely increasing and the amount of the toner supplied from extremely decreasing, thereby effectively preventing decreasing the image density and producing defective images.

### Toner Accommodating Unit

The toner accommodating unit in the present disclosure contains the toner of the present disclosure in a unit capable of accommodating the toner.

Examples of the toner accommodating unit include, but are not limited to, a toner accommodating container, a developing unit, and a process cartridge.

The toner container is a vessel containing a toner.

The developing unit accommodates the toner and develops an image with the toner.

The process cartridge integrally includes at least an image bearer and a developing device, accommodates toner, and is detachably attachable to an image forming apparatus. The process cartridge may further include at least one member selected from the group consisting of a charger, an exposure, and a cleaning device.

The toner accommodating unit of the present disclosure contains the toner of the present disclosure. An image forming apparatus equipped with the toner accommodating unit of the present disclosure consistently produces quality images over an extended term because the toner with robust stress resilience and excellent low temperature fixability is used.

### Image Forming Apparatus and Image Forming Method

The image forming apparatus of the present disclosure includes at least a latent electrostatic image bearer or photoreceptor, a latent electrostatic image forming device, a developing device, a transfer device, and a fixing device with other optional devices such as a cleaner, a discharging device, a recycling device, and a control device.

The image forming method of the present disclosure includes forming a latent electrostatic image on a latent electrostatic image bearer, developing the latent electrostatic image, transferring the developed image, fixing the transferred image, and optionally cleaning the latent electrostatic image bearer, discharging the latent electrostatic image bearer, recycling, and controlling.

The image forming apparatus of the present disclosure suitably executes the image forming method of the present disclosure. In the forming, the latent electrostatic image is formed with the latent electrostatic image forming device. The developing is conducted with the developing device. The transferring is conducted with the transfer device. The fixing is conducted with the fixing device. The other optional processes are conducted with the corresponding optional devices.

### Latent Electrostatic Image Forming Step and Latent Electrostatic Image Forming Device

In the forming a latent electrostatic image, a latent electrostatic image is formed on a latent electrostatic image bearer.

The latent electrostatic image forming device forms a latent electrostatic image on the latent electrostatic image bearer.

There is no specific limitation to the latent electrostatic image bearer (also referred to as electrophotographic insulator, photoconductor, or photoreceptor) with regard to factors such as material, form, structure, and size and a suitable latent electrostatic image bearer can be selected among known bearers. A latent electrostatic image bearer with a drum-like form is preferable. From a material point of view, an inorganic photoconductor made of amorphous silicone or selenium and an organic photoconductor (OPC) made of polysilane or phthalopolymethine are suitable.

An example of the organic photoconductor is a layered photoconductor, including layers—a charge-generating layer formed of non-metallic materials like phthalocyanines or titanyl phthalocyanines dispersed in a binder resin and a charge-transport layer formed of charge transport materials dispersed in a binder resin—stacked on a substrate such as an aluminum drum.

Another type is a single-layer photoconductor with a single-layer structure on a substrate, featuring a photosensitive layer formed of both charge-generating and charge-transport materials dispersed in a binder resin. The single-laver photoconductor may contain add hole transport agents and electron transport agents as the charge-transport materials.

Additionally, the option exists to include an undercoat layer between the substrate and either the charge-generating layer in the laminate photoconductor or the photosensitive layer in the single-layer photoconductor.

One way of forming a latent electrostatic image is to uniformly charge the surface of the latent electrostatic image bearer and irradiate the surface according to the image information obtained using the latent electrostatic image forming device.

The latent electrostatic image forming device includes at least a charger that uniformly charges the surface of the image bearer and an irradiator that irradiates the surface of the image bearer according to the image information obtained.

Charging is accomplished, for instance, by applying a bias to the surface of the image bearer using the charger.

The charger is not particularly limited and can be suitably selected to suit to a particular application.

Specific examples include, but are not limited to, a known contact type charger that includes an electroconductive or semiconductive roller, brush, film, or a rubber blade, and a non-contact type charger using corona discharging such as corotron and scorotron.

Preferably, the charger is disposed in contact or non-contact with the latent electrostatic image bearer and applies a direct voltage and an alternating voltage superimposed thereon to the surface of the image bearer. Moreover, the charger is preferably a charging roller disposed in the proximity of the image bearer via a gap tape to avoid a direct contact with the image bearer and applies a direct voltage and an alternating voltage superimposed thereon to the surface of the image bearer.

The irradiation is conducted by, for example, irradiating the surface of the latent electrostatic image bearer with the irradiator.

There is no particular limitation to the irradiator and it can be suitably selected to suit to a particular application as long as the irradiator can irradiate the surface of an image bearer charged with a charger according to image information.

Specific examples include, but are not limited to, a photocopying optical system, a rod lens array system, a laser optical system, and a liquid crystal shutter optical system. A rear side irradiation system that irradiates the image bearer from the rear side thereof can be also employed.

### Development Process and Development Device

In the developing, the latent electrostatic image is developed with the toner of the present disclosure or the developing agent to render the latent electrostatic image visible.

The developing device develops the latent electrostatic image with the toner of the present disclosure or the developing agent to render the latent electrostatic image visible.

The visible image is formed by, for example, developing the latent electrostatic image with the toner of the present disclosure or the developing agent with the developing device.

The developing device is not particularly limited and can be selected from the known developing devices that can conduct development with the development agent of the present disclosure or the developing agent. For example, a developing device that includes a developing unit accommodating the toner of the present disclosure or developing agent and applies the developing agent to the latent electrostatic image in a contact or non-contact manner is suitably usable. The developing unit preferably includes the toner accommodating unit of the present disclosure that is detachably attached to the developing unit.

The development unit employs a dry or wet development system, and a monochrome development unit or a full color development unit. For example, a development unit including a stirrer that abrasively stirs the toner or the development agent and the rotatable magnet roller is suitable.

In the developing unit, for example, the toner and the carrier are mixed and stirred to triboelectrically charge the toner due to the friction therebetween. The toner is held on the surface of the rotating magnet roller, forming a magnet brush like a filament. Since the magnet roller is provided near the latent electrostatic image bearing member, some of the toner forming the magnet brush on the magnet roller's surface is electrically attracted to the surface of the latent electrostatic image bearing member. As a result, the latent electrostatic image is developed with the toner and rendered visible as a toner image on the surface of the latent electrostatic image bearer. It is preferable to apply an alternating electric field to move the toner to the surface of the latent electrostatic image bearer.

### Transfer Process and Transfer Device

In the transferring, the visible image is transferred to a recording medium.

The transfer device transfers the visible image to a printing medium.

In the transferring mentioned above, the visible image mentioned above is transferred to a printing medium. Preferably, the visible image is primarily transferred to an intermediate transfer member and thereafter secondarily transferred to the printing medium. It is more preferable that, with a two-color toner, preferably a full color toner, the visible image is primarily transferred to an intermediate transfer member to form a complex transfer image and the complex transfer image is thereafter secondarily transferred to the printing medium.

The transferring is conducted by, for example, charging the latent electrostatic image bearer with a transfer charger of the transfer device. The transfer device preferably includes a primary transfer device for transferring visible images to an intermediate transfer body to form a complex transfer image and a secondary transfer device for transferring the complex transfer image to a printing medium.

The transfer device (the primary transfer device and the secondary transfer device) preferably includes at least a transfer unit that peel-off charges the visible image formed on the latent electrostatic image bearer toward the transfer medium. One or more transfer devices can be provided. Specific examples of the transfer unit include, but are not limited to, a corona transfer unit using corona discharging, a transfer belt, a transfer belt, a transfer roller, a pressure transfer roller and an adhesive transfer device.

The intermediate transfer body is not particularly limited and can be suitably selected from the known transfer members including an intermediate transfer belt.

The transfer member is not particularly limited and can be suitably selected from the known printing media, typically printing paper.

### Fixing Process and Fixing Device

In the fixing, the visible image transferred to a printing medium is fixed thereon.

The fixing device fixes the visible image transferred to the printing medium.

Fixing can be conducted every time each color toner image is transferred to a printing medium. Alternatively, fixing can be conducted for a multi-color superimposed toner image.

There is no specific limit to the fixing device and it can be suitably selected to suit to a particular application. Using a known device that applies heating and pressure is preferable. The fixing device includes: a combination of a heating roller and a pressure roller; a combination of a heating roller, a pressure roller, and an endless belt; and a fixing device including a heating member equipped with a heat-generating member, film in contact with the heating member, and a pressing member pressed against the heating member via the film, which fixes a non-fixed image with heat and pressure when a printing substrate with the non-fixed image thereon passes through between the film and the pressing member.

The heating temperature at the fixing device is preferably from 80 to 200 degrees C.

In the present disclosure, for example, any known optical fixing device can be used in addition to or in place of the fixing device and the fixing depending on a particular application.

### Other Processes and Other Devices

In the discharging step, a discharging bias is applied to the latent electrostatic image bearer by a discharging device.

The discharging device is not particularly limited as long as it can apply a discharging bias to the latent electrostatic image bearer. It can be selected among the known discharging devices. One example is a discharging lamp.

In the cleaning step, toner remaining on the surface of the latent electrostatic image bearer is removed, which can be suitably conducted by a cleaner.

As the cleaner, any known cleaner that can remove the toner remaining on the surface of the latent electrostatic image bearer is suitable. For example, a magnetic brush cleaner, an electrostatic brush cleaner, a magnetic roller cleaner, a blade cleaner, a brush cleaner, and a web cleaner are preferable.

In the recycling step, the toner removed in the cleaning step mentioned above is returned to the developing device for re-use. This recycling process is suitably conducted by a recycling device.

There is no specific limit to the recycling device and any known conveying device, etc., can be used.

The controlling controls the processes mentioned above and can be suitably conducted with a controlling device.

The controlling device (controller) is not particularly limited and can be suitably selected to suit to a particular application as long as it can control the behavior of each device. Specific examples include, but are not limited to, a sequencer and a computer.

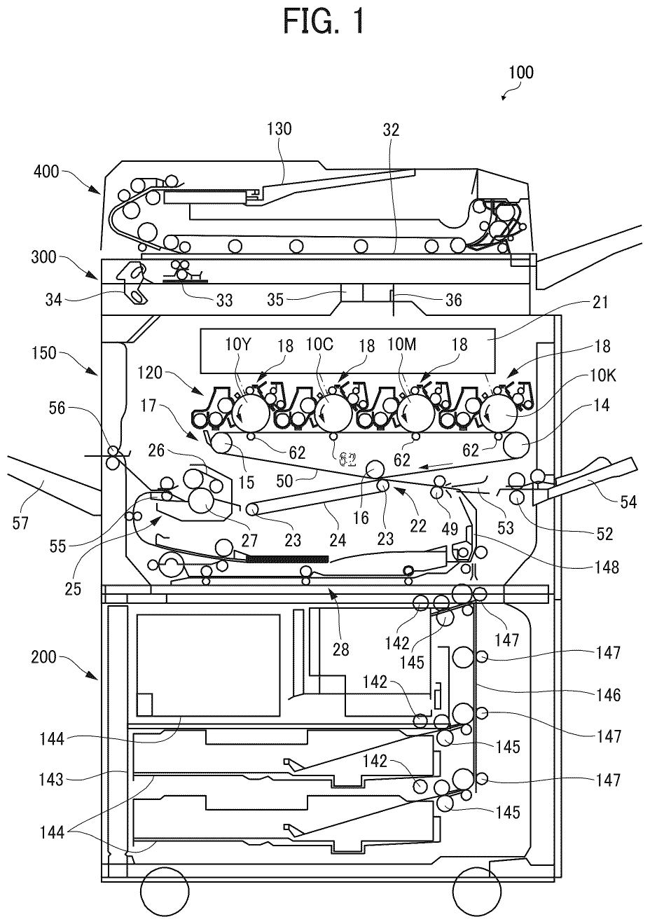

Other embodiments of the image forming method of the present disclosure are described with reference to FIG. 1.

FIG. 1 is a diagram illustrating a color image forming apparatus employing a tandem system. The image forming apparatus includes a photocopying unit 150, a sheet feeding table 200, a scanner 300, and an automatic document feeder (ADF) 400.

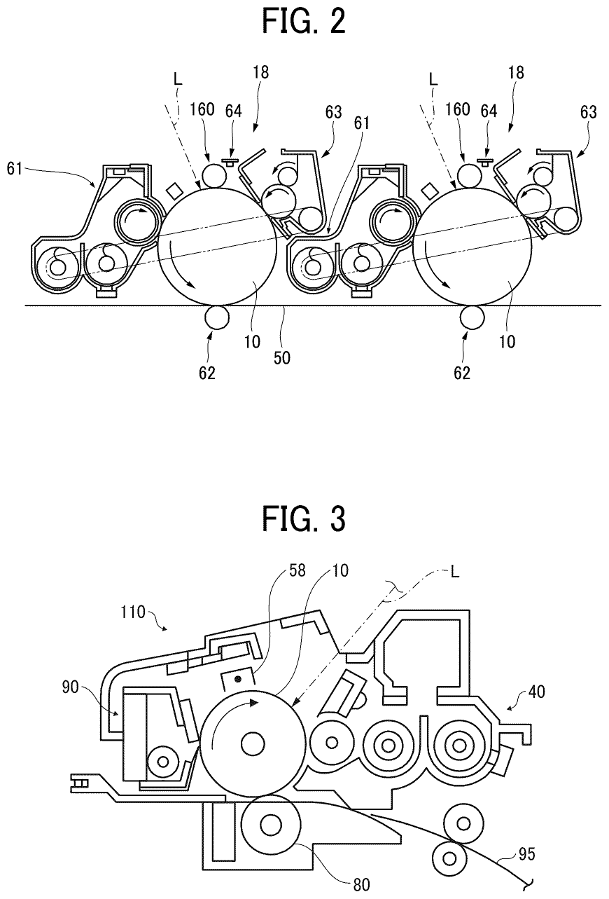

The photocopying unit 150 of the image forming apparatus has an intermediate transfer member 50 with an endless belt disposed at the center thereof. The intermediate transfer member 50 is stretched over support rollers 14, 15 and 16 and rotatable clockwise in FIG. 2. An intermediate transfer member cleaner 17 is disposed around the support roller 15 to remove residual toner on the intermediate transfer member 50. An image forming device 120 with four image forming units 18 of yellow, cyan, magenta, and black is disposed along the intermediate transfer member 50 stretched over the support rollers 14 and 15. In addition, an irradiator 21 is disposed near the image forming device 120. The secondary transfer device 22 is disposed facing the image forming device 120 with the intermediate transfer member 50 between. In the secondary transfer device 22, a secondary transfer belt 24 having an endless form is stretched over a pair of rollers 23. A transfer medium transferred on the secondary transfer belt 24 can be brought into contact with the intermediate transfer member 50. A fixing device 25 is disposed near the secondary transfer device 22. The fixing device 25 includes a fixing belt 26 having an endless form and a pressure roller 27 pressed against the fixing belt 26.

In addition, in an image forming apparatus 100 employing a tandem system, a sheet reverse device 28 for forming images on both sides of the printing medium by reversing the printing medium is disposed near the secondary transfer device 22 and the fixing device 25.

Next, how a full color image is formed with the image forming device 120 is described. First, an original is set on a document table 130 in the automatic document feeder 400. Alternatively, the automatic document feeder 400 is opened to set an original on a contact glass 32 for the scanner 300, and then the automatic document feeder 400 is closed.

When the start button is pressed, the scanner 300 is immediately driven to scan the original on the contact glass 32 with a first scanning unit 33 and a second scanning unit 34 in the case where the original is set on the contact glass 32.

On the other hand, the scanner 300 is driven after the original is moved to the contact glass 32 in the case in which the original is set on the automatic document feeder 400. Then the original is irradiated with light from the first scanning unit 33. The reflection light from the original is redirected at the mirror of the second scanning unit 34. The redirected light is received at a reading sensor 36 via an imaging forming lens 35 to read the color original to obtain image data information for black, yellow, magenta, and cyan. Each image datum is transmitted to each image forming unit 18 in the image forming device 120 to form each visible image of black, yellow, magenta, and cyan.

Each image datum for black, yellow, magenta, and cyan is transmitted to each image forming unit 18 (image forming units for black, yellow, magenta, and cyan) in the image forming device 120 employing a tandem system to form each color toner image of black, yellow, magenta, and cyan at each image forming unit 18.

As illustrated in FIG. 2, each image forming unit 18 (image forming units for black, yellow, magenta and cyan) in the image forming device 120 includes a latent electrostatic image bearer 10 (a latent electrostatic image bearer 10K for black, a latent electrostatic image bearer 10Y for yellow, a latent electrostatic image bearer 10M for magenta, and a latent electrostatic image bearer 10C for cyan), a charger 160 that uniformly charges the latent electrostatic image bearer 10, an irradiator that irradiates the latent electrostatic image bearer 10 with beams of light L according to each color image datum to form a latent electrostatic image corresponding to each color image on the latent electrostatic image bearer 10, a developing unit 61 that forms a toner image with each color toner by developing each latent electrostatic image with each color toner (black toner, yellow toner, magenta toner, and cyan toner), a transfer charger 62 that transfers the toner image to the intermediate transfer member 50, a cleaner 63, and a discharging device 64. Therefore, each single color image (black image, yellow image, magenta image, and cyan image) can be formed based on each color image datum. The black image, the yellow image, the magenta image, and the cyan image formed on the latent electrostatic image bearer 10K for black, the latent electrostatic image bearer 10Y for yellow, the latent electrostatic image bearer 10M for magenta, and the latent electrostatic image bearer 10C for cyan, respectively, are primarily transferred sequentially to the intermediate transfer member 50 rotated by the support rollers 14, 15, and 16. Then the black image, the yellow image, the magenta image, and the cyan image are superimposed on the intermediate transfer member 50 to form a synthetic color composite image (color transfer image).

In the sheet feeding table 200, one of the sheet feeding rollers 142 is selectively rotated to bring up printing media (sheets) from one of multiple sheet cassettes 144 stacked in a sheet bank 143. A separating roller 145 separates the printing media one by one to feed it to a sheet path 146. Transfer rollers 147 transfer and guide the printing medium to a sheet path 148 in the photocopying unit 150 of the image forming apparatus 100. Then the printing medium is held at a registration roller 49. Alternatively, a sheet feeding roller 142 is rotated to bring up the printing media (sheets) on a bypass tray 54. The printing media are separated one by one with a separating roller 145, conveyed to a manual sheet path 53, and also halted at the registration roller 49. The registration roller 49 is generally grounded but a bias can be applied thereto to remove paper dust on the printing medium. The registration roller 49 is rotated in synchronization with the overlapped color composite image (color transfer image) on the intermediate transfer member 50 to feed the printing medium (sheet) between the intermediate transfer member 50 and the secondary transfer device 22. The overlapped color composite image is secondarily transferred to the printing medium (sheet) to form a color image thereon. The residual toner remaining on the intermediate transfer member 50 after the image transfer is removed with the intermediate transfer member cleaner 17.

The printing medium (sheet) with transferred color image thereon is conveyed to the secondary transfer device 22 and then sent out to the fixing device 25. The fixing device 25 fixes the overlapped color composite image on the printing medium with heat and pressure. Thereafter, the printing medium is switched with a switching claw 55, then ejected outside with an ejection roller 56, and stacked on an ejection tray 57. Alternatively, the printing medium is switched with a switching claw 55, reversed with the sheet reverse device 28, and guided again to the transfer position. Then an image is formed on the reverse side. Thereafter, the printing medium is ejected with the ejection roller 56 and stacked on the ejection tray 57.

One embodiment of the process cartridge of the present disclosure is illustrated in FIG. 3. The process cartridge 110 of the present embodiment includes the latent electrostatic image bearer 10 inside, as illustrated in FIG. 3. The latent electrostatic image bearer 10 includes a charger 58 as a charging device, a developer 40 as a developing device, a cleaner 90 as a cleaning device, and other optional devices. The latent electrostatic image bearer 10 is irradiated with beams of light L and a printing medium 95 is fed into the process cartridge 110.

The latent electrostatic image bearer 10 can be the same as that of the latent electrostatic image bearer in an image forming apparatus. Any known charging member is used as the charger 58.

In the image forming process by the process cartridge 110 illustrated in FIG. 3, the latent electrostatic image bearer 10 undergoes charging by the charger 58 and exposure to the beams of light L by the irradiator while rotating in the direction indicated by an arrow, resulting in the formation of an electrostatic latent image corresponding to the exposed image on its surface.

This latent electrostatic image is developed with toner by the developer 40. The toner image obtained is transferred by the transfer roller 80 to the printing medium 95 and printed out. The surface of the latent electrostatic image bearer 10 undergoes cleaning via the cleaner 90 and discharge through a discharging device, and the process cartridge 110 is then ready for the next image formation.

The image forming apparatus implements the image forming method of the present disclosure, consistently delivering high-quality images over extended periods due to the utilization of the toner with strong stress resilience and exceptional low-temperature fixability.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described in detail with reference to Examples but are not limited thereto. In Examples, part means part by mass unless otherwise specified.

### Method of Manufacturing Styrene Acrylic Resin

### Manufacturing Example of Styrene Acrylic Resin 1

A total of 100 percent of xylene, 95.0 parts of styrene, and 5.0 parts of acrylic acid were charged into a reaction vessel, mixed, and the resulting mixture was heated up to 70 degrees C. In a nitrogen atmosphere, a solution of 3.0 parts of tert-butyl hydroperoxide, a radical polymerization initiator, dissolved in 10.0 parts of xylene was added dropwise to the mixture. The mixture was then further heated and maintained at that temperature for 7.5 hours to complete the radical polymerization reaction. The resulting mixture was heated under reduced pressure to remove 60.0 parts of xylene as a solvent, yielding a reaction solution.

Simultaneously, 500.0 parts of methanol were placed in a container equipped with stirring blades and stirred. The previously obtained reaction solution was then added dropwise to the stirred methanol over 1 hour. The resulting precipitate was filtered, rinsed, and dried, yielding Styrene-Acrylic Resin 1 with a number-average molecular weight Mn of 3,500 and a glass transition temperature of 60 degrees C.

### Manufacturing Example of Styrene Acrylic Resin 2

Styrene-Acrylic Resin 2 was obtained in the same manner as Styrene-Acrylic Resin 1 except that the polymerization reaction continued five hours.

Styrene-Acrylic Resin 2 had a number average molecular weight Mn of 3,300 and a glass transition temperature of 56 degrees C.

### Polyethylene Waxed 1 and 2

POLYWAX™ 500 (melting point of 88 degrees C., available from TOYOCHEM CO., LTD.) and Neowax (melting point of 110 degrees C., available from Yasuhara Chemical Co., Ltd.) were respectively used as Polyethylene Wax 1 and Polyethylene Wax 2.

### Example 1

### Manufacturing of Mother Toner A

The feedstock of toner having the formulation below was preliminarily mixed with a HENSCHEL MIXER (FM20B, available from NIPPON COKE & ENGINEERING CO., LTD.) and thereafter melt-kneaded at from 100 to 130 degrees C. with a single-screw kneader (Ko-Kneader, available from BUSS). The thus-obtained kneaded mixture was cooled down to room temperature and coarsely pulverized to 200 to 300 μm with Rotoplex. Next, the coarsely pulverized matter was finely-pulverized under an adjusted pulverization air pressure with a counter jet mill (100AFG, available from Hosokawa Micron Corporation) to achieve a weight average molecular weight of from 5.4±0.3 μm. The finely pulverized matter was classified with an air classifier (EJ-LABO, available from MATSUBO Corporation) with a louver aperture adjusted to achieve a weight average molecular weight of 5.8±0.4 μm and a ratio ow weight average particle diameter to number average particle diameter of 1.25 or less to prepare Mother Toner A with an average circularity of 0.94.

### Formulation

| | | |
|---|---|---|
| Styrene Acrylic Resin 1: | 89.0 | parts |
| Polyethylene Wax 1: | 4.0 | parts |
| Carbon black (C-44, available from | 6.0 | parts |
| Mitsubishi Chemical Corporation): | | |
| Salycylic acid derivative zirconium salt | 1.0 | part |
| (TN-105, available from | | |
| HODOGAYA CHEMICAL CO., LTD.): | | |

### Manufacturing of Toner

A total of 1.5 parts of hydrophobic silica (NY50L, oil-treated silica with an average particle size of 30 nm, available from Nippon Aerosil Co., Ltd.) and 0.1 parts of hydrophobized poly methylsilsesquioxane particles (“Sansheel” MP-01, average particle size of 0.050 μm, polyethylene particles treated with hexamethyldisilazane (HMDZ), available from Tokuyama Corporation) were added to 100 parts of Mother Toner A. This mixture was then stirred and combined using a Henschel mixer to obtain Toner 1 of Example 1.

### Examples 2 to 5

Toners 2 to 5 of Examples 2 to 5 were obtained in the same manner as in Example 1 except that the formulation (composition) was changed to those shown in Table 1 below.

### Example 6

Toner 6 of Example 6 was obtained in the same manner as in Example 1 except that Mother Toner A of Example 1 was replaced with Mother Toner B, which was surface-fused in the following manner.

Mother Toner A obtained in Example 1 was surface-rounded with a surface fusing system (rounding equipment, Meteorainbow MR-10, available from Nippon Pneumatic Mfg. Co., Ltd.) at 196 degrees C.

### Examples 7 to 8

Toners 7 and 8 of Examples 7 and 8 were obtained in the same manner as in Example 1 except that the content of hydrophobized polymethylsilsesquioxane particle was changed as shown in Table 1.

### Comparative Example 1

Toner a of Comparative Example 1 were obtained in the same manner as in Example 1 except that the hydrophobized polymethylsilsesquioxane particle was not added.

### Comparative Examples 2 and 3

Toner b of Comparative Example 2 and Toner c of Comparative Example 3 were obtained in the same manner as in Example 2 and 3 except that the formulation and the glass transition temperature of the toner were changed as shown in Table 2 below.

### Comparative Examples 4 and 5

Toner d of Comparative Example 4 and Toner e of Comparative Example 5 were obtained in the same manner as in Example 4 and 5 except that the formulation and the efflux initiation temperature t by flow tester were changed as shown in Table 2 below.

### Property of Toner

The Toners of Examples 1 to 8 and Comparative Examples 1 to 5 were subjected to the following evaluation. The results are shown in Tables 1 and 2.

### Measuring of Volume Average Particle Diameter of Mother Toner

The volume average particle diameter of Mother Toners was determined by: dispersing the target toner in an electrolyte solution containing a surfactant with an ultrasonic dispersing device (from Honda Electronics Co., Ltd.) for one minute; subsequently, measuring 50,000 particles using the Coulter Multisizer III available from Beckman Coulter, Inc.; and calculating the average diameter from these measurements.

### Measuring of Average Circularity of Mother Toner

The average circularity of Mother Toner was determined by measuring the particles using a flow particle image analyzer (FPIA-3000, available from Sysmex Corporation) and analysing with an analysis software (FPIA-3000. Data Processing Program For FPIA Version 00-10).

Specifically, 0.1 to 0.5 mL at 10 percent by mass surfactant (alkylbenzene sulfonate, NEOGEN SC-A, available from Daiichi Kogyo Co., Ltd.) was placed in a glass beaker; fine particles were added followed by stirring with a microspatula; and 80 ml of deionized water was added to the resulting mixture. The thus-obtained liquid dispersion was subjected to dispersion treatment for three minutes utilizing an ultrasonic wave dispersion device (manufactured by Honda Electronics Co., Ltd.). The shape and distribution of the fine particles were measured until the concentration of the liquid dispersion reached 5,000 to 15,000 particles/μl using FPIA-3000.

### Measuring of Glass Transition Temperature of Binder Resin

The glass transition temperature Tg is determined using a differential scanning calorimeter (DSC 210, available from Seiko Instruments Inc.).

Specifically, a sample weighing between 0.001 to 0.01 g is loaded into an aluminum pan. The sample undergoes a heating cycle from room temperature to 200 degrees C., followed by cooling to 0 degrees C. at a rate of 10 degrees C. per minute, and then reheating at a rate of 10 degrees C. per minute.

The Tg is identified as the intersection point between the extended baseline, which should not exceed the temperature of the endothermic peak, and the tangent showing the steepest slope of the rising part of the peak to its apex.

### Measuring of Efflux Initiation Temperature t by Flow Tester

In measuring the temperature t with a flow tester (CFT-500D, available from Shimadzu Corporation), 1.0 g of the toner sample was heated at a temperature rising speed of 3 degrees C./minute under a load of 22.5 kgf by a piston to be extruded through a nozzle with a diameter of 1.0 mm and a length of 1.0 mm. The piston descent of the flow tester was then plotted against temperature. The position of the piston at 40 degrees in this plot was determined as P (40 degrees C.) and the position of the piston at t degrees C. was determined as P (t degrees C.). In that case, the temperature t measured was determined as the efflux initiation temperature according to the following Relationship 1.

$$P ( t degrees C . ) = 0.1 + P ( 40 degrees C . ) \qquad Relationship 1$$

### Evaluation

The Toners of Examples 1 to 8 and Comparative Examples 1 to 5 were subjected to the following evaluation. The evaluation results are shown in Tables 1 and 2.

### Low Temperature Fixability

Grain long plain paper (TYPE 6000 <70W>, available from Ricoh Co., Ltd.) and copying paper (TYPE 6200, available from Ricoh Co., Ltd.) were placed in a fixing test device including a fixing portion of an image forming apparatus (RICOH P500, available from Ricoh Co., Ltd.) were evaluated for cold offset and smearing. The temperature satisfying both was determined as the fixing temperature and evaluated according to the evaluation criteria below.

### Evaluation Criteria

S: Fixing temperature is 140 or lower degrees C.
A: Fixing temperature is from greater than 140 to 145 degrees C.
B: Fixing temperature is from greater than 145 to 150 degrees C.
C: Fixing temperature surpasses 150 degrees C.

### Cold Offset

To assess the occurrence of cold offset, a solid image was developed at a 0.85±0.2 mg/cm² toner density on plain paper and then fixed while gradually adjusting the fixing roller temperature in 2-degree C increments.

### Smearing Resistance

The evaluation of smearing resistance relied on determining the fixing temperature where the concentration value (Smear ID) of the residual image post-rubbing, conducted with a smear tester (friction testing machine compliant with JIS L0823 standards for color fastness to rubbing), measured 0.4 or less. The Smear ID was assessed using a spectrophotometer (X-Rite, exact, available from X-Rite Inc.).

### Resistance to Developing Process

Resistance to developing process was assessed using an image forming apparatus (ROCOH P500, available from Ricoh Co., Ltd.) with A4 grain short paper (My Paper, available from Ricoh Co., Ltd.).

Specifically, after printing blank on 2,000 continuous sheets, the toner's charge level was measured, and a full solid image was printed. The assessment concentrated on the toner's chargeability (the change rate in toner charge before and after the continuous printing) and the image quality (occurrence of any defective images).

### Chargeability

The evaluation of chargeability was conducted based on the specific evaluation criteria below, utilizing measurements of the change rate in the toner's charge size before and after continuous printing.

### Evaluation Criteria

S: Change rate in charge size of toner is 10 or less percent
A: Change rate in charge size of toner surpasses 10 to less than 15 percent
B: Change rate in charge size of toner surpasses 15 to less than 20 percent
C: Change rate in charge size of toner surpasses 20 percent

### Image Quality

The assessment of image quality relied on the criteria outlined below, involving visual confirmation to identify any defective images characterized by white streaks, fading from the middle of the solid image to its edges, and other irregularities.
S: No defective image
A: Defective images occur at a level that is not bothersome to user
C: Apparently defective images occur

TABLE 1

| | | Example | | | | | | | |
|---|---|---|---|---|---|---|---|---|---|
| | | 1 | 2 | 3 | 4 | 5 | 6 | 7 | 8 |
| Toner | | 1 | 2 | 3 | 4 | 5 | 6 | 7 | 8 |
| Mother | Styrene acrylic resin 1 | 89 | | 91 | | 91 | 89 | 89 | 89 |
| composition | Styrene acrylic resin 2 | | 85 | | 85 | | | | |
| | Polyethylene wax 1 | 4 | | 2 | 8 | | 4 | 4 | 4 |
| | Polyethylene wax 2 | | 8 | | | 2 | | | |
| | Carbon black | 6 | 6 | 6 | 6 | 6 | 6 | 6 | 6 |
| | Salicylic acid derivative zirconium | 1 | 1 | 1 | 1 | 1 | 1 | 1 | 1 |
| | salt | | | | | | | | |
| External | Mother toner | 100 | 100 | 100 | 100 | 100 | 100 | 100 | 100 |
| additive | Hydrophobic silica | 1.5 | 1.5 | 1.5 | 1.5 | 1.5 | 1.5 | 1.5 | 1.5 |
| composition | Polymethylsilsesquioxane particle | 0.1 | 0.1 | 0.1 | 0.1 | 0.1 | 0.1 | 0.1 | 0.5 |
| Toner | Volume average particle diameter | 7.0 | 7.1 | 7.3 | 7.1 | 7.2 | 7.0 | 7.0 | 7.0 |
| property | (μm) | | | | | | | | |
| | Average Circularity | 0.9 | 0.9 | 0.9 | 0.9 | 0.9 | 1 | 0.9 | 0.9 |
| | Glass transition temperature | 58 | 48 | 60 | 50 | 59 | 58 | 58 | 58 |
| | (degrees C.) | | | | | | | | |
| | Efflux initiation temperature t by | 62 | 55 | 64 | 54 | 65 | 62 | 62 | 62 |
| | flow tester | | | | | | | | |
| Evaluation | Fixability | S | S | B | S | B | S | S | A |
| | Cold offset | S | S | A | S | B | S | S | S |
| | Smear resistance | S | S | B | S | B | S | S | A |
| | Image quality | S | A | S | A | S | S | A | S |
| | Chargeability | S | B | S | B | S | S | A | S |

TABLE 2

| | | Comparative Example | | | | |
|---|---|---|---|---|---|---|
| | | 1 | 2 | 3 | 4 | 5 |
| Toner | | a | b | c | d | e |
| Mother | Styrene acrylic resin 1 | 89 | | 92 | | 92 |
| composition | Styrene acrylic resin 2 | | 84 | | 84 | |
| | Polyethylene wax 1 | 4 | | 1 | 9 | |
| | Polyethylene wax 2 | | 9 | | | 1 |
| | Carbon black | 6 | 6 | 6 | 6 | 6 |
| | Salicylic acid derivative zirconium | 1 | 1 | 1 | 1 | 1 |
| | salt | | | | | |
| External | Mother toner | 100 | 100 | 100 | 100 | 100 |
| additive | Hydrophobic silica | 1.5 | 1.5 | 1.5 | 1.5 | 1.5 |
| composition | Polymethylsilsesquioxane particle | | 0.1 | 0.1 | 0.1 | 0.1 |
| Toner | Volume average particle diameter | 7.0 | 7.3 | 7.0 | 6.9 | 7.2 |
| property | (μm) | | | | | |
| | Average Circularity | 0.9 | 0.9 | 0.9 | 0.9 | 0.9 |
| | Glass transition temperature | 58 | 47 | 61 | 48 | 60 |
| | (degrees C.) | | | | | |
| | Efflux initiation temperature t by | 62 | 54 | 64 | 53 | 66 |
| | flow tester | | | | | |
| Evaluation | Fixability | S | S | C | S | C |
| | Cold offset | S | S | B | S | B |
| | Smear resistance | S | S | C | S | C |
| | Image quality | C | A | S | A | S |
| | Chargeability | B | C | S | C | S |

From the above, the toner of the present disclosure, which includes hydrophobized polymethylsilsesquioxane particles as an external additive into a single-component toner with excellent low-temperature fixability, demonstrates very high surface retention even in toners with excellent low-temperature fixability. This ability allows for maintaining the toner's chargeability and flowability even under stress during the development process. Therefore, it has become evident that the toner is resistant to stress, excels in low-temperature fixability, and can form high-quality images over the long term.

Aspects of the present disclosure are, for example, as follows.
Aspect 1: A toner contains a mother toner particle that containing a binder resin, a release agent, and a charge control agent, and an external additive that contains a hydrophobized polymethylsilsesquioxane particle wherein the toner has a glass transition temperature of from 48 to 60 degrees C., and a temperature of 1.0 g of the toner is from 54 to 65 degrees C. when the 1.0 g of the toner is pushed in 0.1 mm by the piston of a flow tester in heating the 1.0 g of the toner from 40 degrees C. at a temperature rising speed of 3 degrees C. per minute under a load of 22.5 kgf.
Aspect 2: The toner according to Aspect 1. wherein the binder resin contains a styrene acrylic resin, and the release agent contains a polyethylene wax.
Aspect 3: The toner according to Aspect 1 or 2, wherein the proportion of the release agent ranges from 2 to 8 parts by mass to 100 parts by mass of the toner.
Aspect 4: The toner according to any one of Aspects 1 to 3. wherein the mother toner particle is a pulverized toner and has an average circularity of 0.96 or less.
Aspect 5: The toner according to any one of Aspects 1 to 4, wherein the proportion of the hydrophobized polymethylsilsesquioxane particles is from 0.05 to 0.5 parts by mass to 100 parts by mass of the toner.
Aspect 6: A toner accommodating unit containing the toner of any one of Aspects 1 to 5.
Aspect 7: An image forming apparatus includes a latent electrostatic image bearer, a latent electrostatic image forming device for forming a latent electrostatic image on the latent electrostatic image bearer, a developing device for developing the latent electrostatic image formed on the latent electrostatic image bearer with the toner of any one of Aspects 1 to 5 mentioned above to obtain a visible image, a transfer device for transferring the visible image onto a transfer medium, and a fixing device for fixing the visible image transferred to the transfer medium.
Aspect 8: An image forming method includes forming a latent electrostatic image on a latent electrostatic image bearer, developing the latent electrostatic image formed on the latent electrostatic image bearer with the toner of any one of Aspects 1 to 5 to obtain a visible image, transferring the visible image formed on the latent electrostatic image bearer to a transfer medium, and fixing the visible image on the transfer medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
a mother toner particle comprising:
a binder resin;
a release agent; and
a charge control agent; and
an external additive comprising:
a hydrophobized poly methylsilsesquioxane particle,
wherein the toner has a glass transition temperature of from 48 to 60 degrees C., and
a temperature of 1.0 g of the toner is from 54 to 65 degrees C. when the 1.0 g of the toner is pushed in 0.1 mm by a piston of a flow tester in heating the 1.0 g of the toner from 40 degrees C. at a temperature rising speed of 3 degrees C. per minute under a load of 22.5 kgf.

2. The toner according to claim 1,
wherein the binder resin comprises a styrene acrylic resin, and
the release agent comprises a polyethylene wax.

3. The toner according to claim 1,
wherein a proportion of the release agent ranges from 2 to 8 parts by mass to 100 parts by mass of the toner.

4. The toner according to claim 1,
wherein the mother toner particle is a pulverized toner and has an average circularity of 0.96 or less.

5. The toner according to claim 1,
wherein a proportion of the hydrophobized polymethylsilsesquioxane particles is from 0.05 to 0.5 parts by mass to 100 parts by mass of the toner.

6. A toner accommodating unit containing the toner of claim 1.

7. An image forming apparatus comprising:
a latent electrostatic image bearer;
a latent electrostatic image forming device to form a latent electrostatic image on the latent electrostatic image bearer;
a developing device to develop the latent electrostatic image formed on the latent electrostatic image bearer with the toner of claim 1 to obtain a visible image;
a transfer device to transfer the visible image onto a transfer medium; and
a fixing device to fix the visible image transferred to the transfer medium.

8. An image forming method comprising:
forming a latent electrostatic image on a latent electrostatic image bearer;
developing the latent electrostatic image formed on the latent electrostatic image bearer with the toner of claim 1 to obtain a visible image;
transferring the visible image formed on the latent electrostatic image bearer to a transfer medium; and
fixing the visible image on the transfer medium.
